(19) United States
(12) Patent Application Publication
(10) Pub. No.: US 2022/0232824 A1
(43) Pub. Date: Jul. 28, 2022

(54) ANTI-PEST GUARDIAN BARRIER INCLUDING AN ARTICLE/SUBSTRATE PROTECTING DRYING OIL

(71) Applicant: Ralph Waldo EMERSON, Napa, CA (US)

(72) Inventor: Ralph Waldo EMERSON, Napa, CA (US)

(21) Appl. No.: 17/518,353

(22) Filed: Nov. 3, 2021

Related U.S. Application Data
(62) Division of application No. 16/191,028, filed on Nov. 14, 2018, now abandoned.
(60) Provisional application No. 62/585,814, filed on Nov. 14, 2017.

(51) Int. Cl. A01N 25/10; A01N 65/00; A01N 3/00

(52) U.S. Cl. CPC A01N 25/10; A01N 3/00; A01N 65/00

(57) ABSTRACT

A barrier material is formed of an elastomeric polymer and a drying or volatile oil which may be desirably obtained from the genus or species of the plant being treated. The drying or volatile oil cures from the addition of oxygen to its organic compound to product crosslinking which enhances the rheological attributes of the barrier.

### CROSS-REFERENCE TO RELATED APPLICATIONS

The present application is a divisional of co-pending application Ser. No. 16/191,028, filed Nov. 14, 2018, which claims the benefit of U.S. Provisional Application No. 62/585,814 filed on Nov. 14, 2017, all of which are incorporated herein by reference.

### FIELD OF THE INVENTION

The present invention relates to compositions comprising an elastomer and a drying or volatile oil and preferably a regulation exempt organic elastomer and an appropriate FIFRA exempt edible drying or volatile oil to provide a physical barrier for plants and plant products and particularly agricultural products.

### BACKGROUND AND SUMMARY OF THE INVENTION

Plant pathogens are known to be extremely detrimental to man and the agricultural environment. Such pathogens can infest crops and cause tremendous economic damage to crops while being able to infest animals including man. For example, various methods for controlling pathogens on plants have included spraying crops with pesticide chemistries on 3-21 day intervals when environmental conditions favor pest development. Many pesticides are no longer available due to either resistance or non-target toxicological problems.

Whereas commercial agriculture historically made use of the wide-spread application of pesticides, environmental concerns and the aforementioned resistance that many pathogens acquired to pesticide chemistries have made it increasingly important to develop an alternative pathogen control strategy.

At the same time, there is increasing demand in the market for organic agricultural products. Traditional pesticide chemistries may not be typically used to produce such organic agricultural products and thus there is increasing demand for an alternative. One approach is the use of organic anti-pathogenic materials. For example, citronella, obtained from different species of cymbopogon (lemon grass) has been used as a plant based insect repellant and has been used as a bio-pesticide.

There is a considerable demand for a treatment that will protect plants from known pathogens without the use of traditional pesticides. One possible approach for the inhibition of plant pathogens is to provide a barrier layer to protect a particularly sensitive portion of the plant. For example, the use of latex based wound dressings. R was known, to use liquid latex, often combined with a pigment as a wound dressing. See, for example, U.S. Pat. No. 2,203,274 to Anderson. Such dressings were generally applied only to a pruning wound, were intended to only cover the freshly wound, and were not typically persistent to protect the wound for a substantial length of time.

According to the teachings of the present application, a guardian barrier has been produced which is improved over those known in the prior art, may be used to provide large-scale treatment for the whole plant system, and which is configured to provide a more complete and persistent protection of the plant system to which it is applied. According to the teachings of the present application, a liquid carrier, includes and elastomeric polymer and at least one drying oil. The drying oil serves to enhance the ability of the elastomeric polymer to adhere to the plant and protects the polymer coating from microbial damage.

According to one embodiment of the present invention, the elastomeric polymer is an acrylic elastomeric polymer combined with a drying oil, more particularly an edible drying oil. In an alternative embodiment, an elastomeric organic polymer may be beneficially utilized. Such an organic elastomeric polymer is exempt from regulation when used in foodstuffs and may therefore be considered natural as that term is used in agricultural fields.

The elastomeric polymer, and preferably an organic elastomeric polymer, is mixed with a drying or volatile oil. Typically, curing of the drying or volatile oil results from the addition of oxygen to an organic compound resulting in chemical crosslinking. Thus, the drying or curing of the coating is a result of autooxidation resulting in polymerization into a solid form.

The guardian barrier coating produced according to the present invention may be diluted to a suitable concentration with water and applied to plants where it dries as a barrier coating effectively protecting the plant from exposure to an undesired pathogen.

### BRIEF DESCRIPTION OF THE DRAWINGS

FIG. 1 is a chart showing the efficacy of the combination of a polymer barrier and hemp oil compared to polymer barrier only or no barrier.

FIG. 2 is a chart comparing the performance of a barrier polymer combined with an essential oil according to the teachings of the present application compared to the commercially available treatment to attenuate the severity and incidence of powdery mildew.

### DETAILED DESCRIPTION OF PREFERRED EMBODIMENTS

According to the teachings of the present application, the barrier coating provides a barrier against pest access and in accordance with the teachings of the present application may be used as:
1) a live plant guardian barrier;
2) a guardian barrier to desiccation and spoilage for plant parts during transportation and storage; and
3) a protective barrier coating for plant seeds or other propagative stock such as bulbs, corms; rhizomes, cuttings, tubers, etc., for the prevention of loss to pathogens and pests;
4) a harvest wound guardian dressing elastic bandage intended to serve as a barrier to pest access; and
5) a soot smoke taint barrier.

While the guardian barrier produced according to the teachings of the present application may include an elastomer and a drying or volatile oil, in combination, it is within the contemplation of the present application to add known anti-pathogenic materials to the barrier coating in accordance with the teachings of the present invention. For example, an oil having known anti-pathogenic effect such as oil of cinnamon may be added for the purpose of additional discouragement of a particular pathogen. Alternatively, it is possible to include a known chemical pesticide in the wound dressing, should this be considered beneficial for particular application.

According to the teachings of the present application, an elastomeric polymer and a drying or volatile oil ingredient provide an effective barrier layer. The elastomeric polymer may be an acrylic elastomeric polymer or an organic elastomer.

One possible elastomeric polymer ingredient is an organic elastomer such as an ionic water soluble polymer containing carboxylate and sulfate groups. One such example is Poly Hydra-O (Syn-Bionic Evolution INC, Pollard-Des-Ormeaux, Québec, CANADA) Typical concentration—0.015% to 20% range by volume although the preferred range is 0.1% to 5% by volume. Typically, curing of the drying or volatile oil ingredient results from the addition of oxygen to an organic molecule (compound) and the following chemical cross linking. This drying or curing is a result of autoxidation that can polymerize into a solid form.

PolyHydra-O contains a material bearing the CAS #9003-01-4 which is one of a class of polyacrylic acids (PAA) that can maneuvered with different molecular weights and additives to and may be varied to enhance the polymer/barrier.

The PAA is an anionic polymer. That is to say i.e., many of the side chains of PAA will lose their protons and require a positive charge. This means that the PAAs will have the ability to absorb and retain water, which allows them to swell many times their original volume. PAA has a trade name “Carbomer” codes 910, 934, 940, 941, and 934p are all various molecular weights and can be a specific components of the polymer. In the aqueous solutions the sodium ions are free, for example (sodium polyacrylate), to move since they are placed with positivity charged hydrogen ions.

Some of most relevant drying or volatile oils include poppy seed oil, grape seed oil, hemp oil, perilla oil, walnut oil, cinnamon oil, castor oil, clove oil, corn oil, garlic oil, linseed oil, peppermint oil, rosemary oil, sesame oil, soybean oil, spearmint oil, and thyme oil. In one set of experiments the addition to the polymer barrier of a drying or volatile oil is shown in the graph below which summarizes the result of experimental testing in test plots of grape vines for the control of wood and trunk diseases.

The organic elastomer Polyhydra O as identified above was applied with a concentration of both 1 and 2% by applied volume to form the Polymer Barrier. The polymer barrier was applied to vines in test sample one. A second test was performed with the same polymer barrier at the same concentrations but Hemp oil was added to a concentration of 3000 ppm or 0.3% was added as drying or volatile oil. The control sample was sprayed with distilled water only.

The samples were inoculated with a known strain of Eutypa lata (trunk disease) and incubated for 72 hours. Four samples with an organic elastomer concentration of 1% and four samples with an organic elastomeric concentration of 2% were monitored. Similarly, four samples of each concentration of organic elastomer were tested with the 0.3% Hemp oil concentration. For control samples of water were tested.

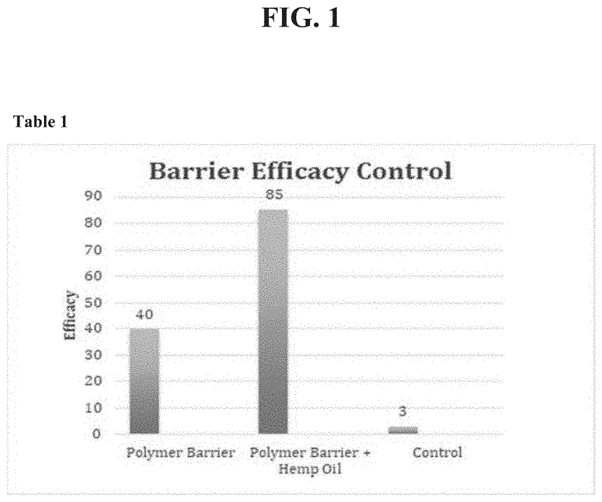

FIG. 1 illustrates that the average results for the samples tested. The efficacy of the difference in concentration between 1% and 2% of organic elastomer was found to not be statistically significant so the results show below represent all 8 tests of organic elastomer alone and all 8 tests of organic elastomer with Hemp oil. The barrier polymer demonstrated an average efficacy of 40%. Addition of the drying or volatile oil enhanced the performance to 85% efficacy. The control exhibited 3% efficacy which was statistically insignificant.

Although applicants recognize that the principals of the present application also apply to inorganic polymer barriers, in some ways it is preferable to use naturally occurring compounds including, in particular, compounds recognized as organic and exempt from FIFRA registration by various organizations and the U.S. Environmental Protection Agency (EPA), which are non-phytotoxic at recommended dosages while providing guardian protection against pathogens and pests.

The present invention preferably employs FIFRA exempt materials in the plant guardian barrier produced in accordance with the teachings of the present application. Embodiments of the present application typically are formulated in a dilute form for spraying or painting on the plant material to be protected. However, the techniques of the present application may also be applicable for use in a spreadable paste formulation to create the guardian barrier of the present application.

The polymer of the present preferred embodiment as tested and reported with respect to Table 1 forms a suspended in water-soluble gel matrix. The polymer has rheological attributes that cause it to morph and adapt to various hydrophobic/hydrophilic ambient conditions while temperatures vary. The barrier employing an edible drying or volatile oil allows plant restoration, natural growth, and may even improve yield. The polymer used in one embodiment of the invention meets USDA National Organic Program (NOP) requirements. It is virtually non-toxic and formulated with polymers listed on the EPA's GRAS list (generally regarded as safe).

It is also possible to use an inorganic polymer. One contemplated polymer usable with a drying or volatile oil has a trade name of Anti-Stress 550, having an active ingredient of Acrylic Polymer latex. The manufacturer, Polymer Ag LLC, has kept the CAS number(s) proprietary as permitted by 29.CFR 1910.1200(i). However, such a polymer may not be exempt from EPA's FIFRA regulations: 40 CFR 152.10 and State of California exemption under 3 CCR section 6147.

Although the tests done so far by the applicants have shown efficacy with concentrations of polymer in the 1%-2% range, it is expected that similar effects are exhibited at higher concentrations and that significant benefits will occur with lower concentrations as well.

It is anticipated that the range or concentrations of the polymer having substantial efficacy will be in approximately 0.015% to 20% range by volume. The preferred range is 0.1% to 5%.

The drying or volatile oil cures from the addition of oxygen to its organic compound to produce cross linking. Thus, the oil cures or dries as a result of autoxidation that may polymerize into a solid form.

FIG. 1 demonstrates the efficacy of a barrier employing only polymer as compared to the polymer with a drying or volatile oil, in that case the drying or volatile oil combined with the polymer is hemp oil (hemp seed oil) cold pressed and then refined to a colorless and clear liquid. Hemp (Cannabis sativa) is an angiosperm belonging to the cannabaceae family and Cannabis genus. Hemp oil is produced from varieties of Cannabis sativa and is commercially available. Although the test illustrated in the chart of FIG. 1 used the hemp oil at approximately 0.3% by volume or one third to one sixth the volume of the elastomeric polymer, other concentrations are within the contemplation of the inventor. Specifically, it is anticipated that the concentration of the drying or volatile oil should be about 0.01 to 10% by volume and maybe particularly efficacious at 0.05% or greater and may show declining benefit improvements at concentrations of greater that 1.0% by volume.

While the oil used in the embodiment of FIG. 1 is hemp oil, it is contemplated that any edible drying or volatile oil may be employed. For example, walnut oil, grape seed oil, or any other edible drying or volatile oil may be used. Hemp seed oil has a high percentage of polysaturated fatty acids with an iodine adsorption value of about 163.5. Preferable oil iodine numbers are from 120-180.

It is within the contemplation of the present invention that an organic or pesticide may be used as an adjunct by mixing with the barrier coating to improve its efficacy. Alternatively, a number or edible drying or volatile oils may have an anti-pathogenic effects. A number of these ingredients are listed on minimum risk pesticide products, such as cinnamon oil, citronella oil, or another oil that has been shown to have anti-pathogenic effects, as compared to hemp oil. It is anticipated that such a drying or volatile edible oil having efficacy in deterring pathogens can also either be added or used as a drying or volatile oil that performs the drying or volatile oil function as well an acting as an antipathogen.

It appears that based on initial trials, there may be some benefit to using a drying or volatile oil produced from the plant species or at least genera to which the barrier is to be administered. This is the concept of agrohomeopathy which derives its power from the Law of Similars. Simply stated “like is cured by like”. One class of chemistry produced by many plants is that of drying or volatile oils. The drying or volatile oil may be beneficially an oil of produced from the plant species to which the barrier is to be administered. Thus the drying or volatile oil may be beneficially from the genus or species of plant being treated with the guardian barrier according to the teachings of the present application.

The guardian barrier produced according to the teachings of the present application, when dried, sticks and serves to provide a natural excluding barrier from deleterious infection from pathogens and other vascular compromising pests. This guardian barrier has application for:
wounds that are freshly formed (post-injury), lasting the duration of the wounds' susceptibility period and longer while not interrupting important stages of plant and fruit development;
root stock in storage where the sealant also serves as a barrier to dehydration until planting; and
seeds where it is used as a surface coating;
other applications such as controlling plant transpiration to reduce crop water use.
post-harvest ag crop product protection

The present preferred embodiments preferably comprise a liquid carrier (or a solid binder) which includes an elastomeric polymer such as an acrylic elastomeric polymer and at least one edible drying or volatile oil ingredient. The drying or volatile oil serves to enhance the ability of the elastomeric polymer to adhere to the plant and protect the polymer coating from microbial damage.

Various formulation-enhancing additives, such as de-foaming and anti-freezing agents, and/or pigment may be added to the composition as well.

Another benefit of the present invention is it may be used to lessen seed loss to pests and other pathogens during storage, pre-planting and loss to seedlings after planting, Most pests can be impeded from attacking seeds when they have been coated with the guardian barrier sealant.

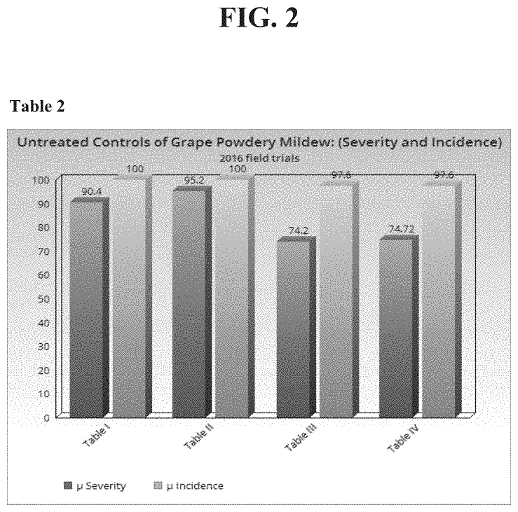

FIG. 2 describes blind field trials performed during the 2016 growing season by the University of California Davis as administered by W. Douglas Gubler, Professor Plant Pathology, UC Davis. These field trials compared a number of approaches to controlling powdery mildew in grape fields. The test fields labeled Table I-IV were first monitored to determine the severity and incidence of powdery mildew without any current treatment. FIG. 2 shows the extent of powdery mildew in each of the test fields.

The study compared the disease incidence and severity after treatment with a number of commercial treatments. The formulation of the present application was tested for efficacy without knowledge of its composition or treatment modality and compared to various commercially available treatments.

The following selected data compared the efficacy of the formulation of Table 1 with several commercially available pesticide products,

### Select Comparison; Various Treatments

// Disease incidence and severity in trials. Product names/by treatment names followed by the same letter are not significantly different according to Fishers LSD at x=0.05. //

| Treatment Against Erysiphe nector | | μ Severity | μ Incidence |
|---|---|---|---|
| 1. | Regalia | 14.4 cde | 84.8 ab |
| 2. | Probiotic | 11.14 de | 88.0 ab |
| 3. | Regalia + Stylet | 13.72 cde | 90.4 ab |
| 4. | Serenade Opti | 15.42 cde | 100.0 a |
| 5. | Rally/Quintec + Syl-Coat | 01.22 b | 37.6 c |
| 6. | Luna Experience alt | | |
| | Quintec + Syl-Coat | 00.57 b | 17.60 cd |
| 7. | Present Barrier with Essential Oil | 00.31 b | 16.80 d |

### Materials/Methods

Design; Complete randomized design with 5 replicates
1. Regalia—extract of Reynoutria sachalinensis plant extract—MARONE BIOSCIENCE
2. Probiotic—FAIRFIELD
3. Regalia+Stylet oil—NIS STYLET OIL
4. Serenade—Bacillus subtilis QST713 Strain—BAYER CROP SCIENCES
5. Rally/Quintec—DMI Triazole/quinolone—DOW AGRO SCIENCES
6. Luna Experience/Quintec+Syl-Coat (Wilbur-Ellis) Fluopyra/febuconazole BAYER CROP SCIENCES
7. Barrier plus essential oil of FIG. 1

This data was reported in a U.C. Davis report that may be found in detail at http://plantpathology.ucdavis.edu/wp-content/uploads/2016/11/2016-November-3-Grape-Powdery-Mildew-Report.pdf.

From the the results of this report it is apparent that the barrier of the present application actually performed better than the current predominant powdery mildew treatments, including those by Bayer Crop Science and Dow Agro Sciences.

Use of these two elements (elastomeric barrier coating, and an edible drying or volatile oil) prevents exposure to the undesired pathogen, dries the wound making conditions less conducive to propagation of the pathogen. The use of the organic essential edible drying or volatile oil substantially improves performance by setting the barrier quickly.

Typically, the composition according to the teachings of the present invention may be formed as a concentrate and then diluted by a design ratio to form a dilute composition for direct application to the desired plant, the dilution typically being made by mixing the concentrate with water to dilute the concentrate by a suitable amount which may be an order of magnitude typically at the time the composition is prepared for application. This dilute composition may be applied by spraying. In this way the cost of shipping the treatment is drastically reduced.

The composition may take the form of a liquid or paste. Liquid forms of the present sealant composition may be applied to the plant (seed, root stock, wound) by spraying or another delivery technique such as brushing. The composition typically dries within 1 to 12 hour(s) and may retain its barrier effects for as long as 6 months. This longevity can be lessened by dilution to thinner applications, to assure degradation before harvest. Alternatively, the concentrate may be formed into a paste and spread over a wound (for example by troweling or brushing) to facilitate its sealing. The composition typically dries within an hour and retains its prophylactic effects for as long as 3-6 months. Barrier longevity is a function of composition.

The preferred sealant composition is typically recalcitrant to aqueous solubilization. Thus, low concentrations of surfactant may be desirable to produce a usable emulsion containing a concentration of an organic edible drying essential oil compound. In addition to the core active emulsion above, other inert ingredients may be included to promote the viscoelasticity and weak inter-molecular forces of the resultant sealant.

This guardian barrier coating composition of the preferred embodiment is suitable for pest exclusion application to various stages in plant development as well as wound treatment and other injuries. The composition serves to promote the wellbeing of the plant and healing of the wound while excluding other pathogens from infecting the plant through contact with the plant or its parts. The use of this composition in various applications beneficially protects the plant material from pathogenic attack by various organisms.

An edible drying or volatile oil inert ingredient may also contain a natural saponin surfactant from old 4a FIFRA exemption list.

The present invention is a crop management tool well suited to Integrated Pest Management (IPM) Systems. As a prophylactic treatment, the mode is pest exclusion via guardian barrier although inclusion of an antipathogen may give further benefit by attenuation of the pathogens that are presented to the barrier layer.

It is within the contemplation of the invention to include an anti-pathogen into the Guardian barrier formed according to the teachings of the present invention. For example, an anti-pathogenic organic material such as Cinnamon Oil, or even a FIFRA regulated anti-pathogen may be included as part of the Guardian Barrier. Use of such an anti-pathogen within the Guardian Barrier may provide additional protection by combining the benefits of the Guardian barrier with the additive benefit of the efficacy of the anti-pathogen.

### Guardian Barrier Sealant

Once inside the plant, eradication of these pathogens is problematic. The best P strategy for prevention is a guardian barrier such as described in the present invention.

### Seeds

A seed is an embryonic plant enclosed in a protective coating covering called the seed coat. The formation of the seed completes the process of reproduction in seed plants. Seeds are produced in several related groups of plants and their manner of production distinguishes the angiosperms (enclosed seeds) from the gymnosperms (naked seeds).

Diseases of plants are caused primarily by three types of pathogens: bacteria, fungi and viruses. Even though fungi are the largest class of plant pathogens, many seed-specific diseases are caused by bacteria or viruses.

Pathogens are common in vegetable crops including seed-borne pest pathogens. Often the pathogen is present within or on the seed surface which can cause seed rot and seeding damping-off. Treatment of grain, forage, fruit and vegetable seeds has been shown to prevent plant disease epidemics caused by seed-borne pathogens. Seed treatments can also be useful in reducing the amount of pesticide needed to manage a disease because effective seed treatments can eliminate the need for foliar pesticide application later in the season. Although the application of fungicides is almost always the treatment, non-target environmental impact and the development of pathogen resistance has led to the search for more effective alternative methods. Physical treatments that have already been used and treatments with bio-pesticides such as plant extracts, natural compounds and bio-control agents have proven to be effective in controlling seed-borne pathogens. These have been applied alone or in combination are becoming widely used due to their broad spectrum nature in terms of disease control and production yield. The present invention can also be used in this manner, as a fluid in which seeds might be immersed to coat them, which, upon drying are more resistant to pathogenic attack during storage and later when planted.

A particular property of preferred embodiments of the present invention is a plant guardian property which persists for periods as long as 5-6 months for post-harvest wound protection, root stock & dormant rooting protection during storage between planting, and coating for seeds.

The invention, when used as a physical guardian barrier over the wound, promotes healthy healing and drying, and protects the plant from diseases and maladies that arise from microbial pathogens and pests present not only at post-pruning, but throughout the dormant season to bud break in grapes and other horticultural crops.

This anti-pest property is also evident when the invention is used as an anti-desiccant to prevent loss of root stock that is harvested and prepared for storage in preparation for planting at a later time. This loss results from two major causes; dehydration and spoilage due to pests. The guardian sealant may be applied as a sprayable paint or a troweled or brushed on coating.

Another object of the present invention is to lessen seed loss to pests and other pathogens during storage, pre-planting and loss to seedlings after planting. Most pests can be impeded from attacking seeds when they have been coated with the guardian barrier sealant.

### Soot Smoke Taint

Several seasons of wildfires has caused a multi-million dollar problem with wine grape vineyards. “Smoke taint” as it is commonly called is really a problem with “soot” or ash. Ash composition is a function of the percentage of combustion of the substrate involved. Fire ash has a particular color resulting from degree of the involved fire storm. Ash burned at less than <840° F. carbon is burned off and will be a dark colored carbon black ash. Ash burned at greater than >840° F. will be white. Generally, this white ash may contain contaminants such as arsenic, hexavalent chromium, lead, asbestos and various hydroxide minerals. The latter may result in combustion at temperature greater than >1100° F., which also produces oxides. Wood produces oxides of nitrogen (NOx) and volatile organic compounds (VOCs) as it burns. How the ash (over) mixes is a function of the combustion levels. Other characteristics states are the hydrophobic ash (no water binding), hydrophilic ash will mix with waste (flow to rivers). Both states can interfere with primary productivity, that is the rate at which light energy or inorganic chemical energy is converted to the chemical energy of organic compounds by autotrophs in an ecosystem.

Other bi-products of such combustion polycyclic aromatic are hydrocarbons and dioxin. Particulate matter is a cause of perceived “smoke taint”. Visible smoke in the air is not a gas, but rather is a collection of what is called particulate matter. They are a set of not completing pyrolized matter or sufficient pyrolized to be light enough to fly in air streams. The matter is usually <less than 10 microns in width.

Soot is formed during the combustion of hydrocarbon fuels such as wood, silicon rich grasses, and woody plants. Soot's last form is a solid very similar to graphite that has started as a gaseous hydrocarbon. Data suggests that transitioning from a gas to a liquid before becoming a solid. Scientists is at Sandia National Laboratories at Livermore, Calif. have demonstrated that soot particles are formed when gaseous molecules are heated to high temperatures and they do not form back to gaseous molecules in the manner of water droplets do when heated.

Wildfires release volatile phenols which permeate the grape skins. They bond with sugars inside the skin of the grape and not the pulp. Glycosidal bonds make the phenols non-volatile (order not detected) until the grape goes through maceration and fermentation. At this stage of process acidity breaks apart glycoside, releasing the sugar-phenol bond which is now once again volatile and produces “smoke taint” organalyptics and odors. At this state of wine production, it is very problematic to rework the wine chemistry to proper chemical balances (phenols, glycosides, etc).

A better approach is to spray a barrier coating on the grapes and prevent the soft direct access to the skin of the grape.

### Soot Experiment

The barrier coating of the Table 1 experiment is applied to grape dusters to form treated grape dusters.

Group 1—clusters of untreated SHIRAZ grapes untreated clusters

Group 2—clusters of TREATED (sprayed to run off) with barrier polymer—SHIRAZ grapes

Both treated and untreated SHIRAZ grape clusters are placed in a NBS smoke density chamber*MODEL F2101 (SATATON Corporation) and exposed to wood smoke.

The glycoside percentages of Group 1 and Group 2 are measured to determine the improvement resultant from the barrier coating of the present application.

It is apparent from the above explanation that the barrier coating of the present application containing an elastomeric polymer and an essential drying or volatile oil provides important protection to plants and plant material from a variety of pathogens. Such pathogens include fungi, bacteria, viruses, and arthropods.

I claim:

1. An anti-pest barrier coating for coating plant material to inhibit pathogenic migration into the plant material comprising:
an elastomeric polymer;
a drying or volatile oil.

2. The anti-pest barrier coating of claim 1 wherein the essential drying or volatile oil includes hemp oil and comprises 2-5% by weight of the coating (for a 10× concentrate).

3. The anti-pest barrier coating of claim 2 further comprising a natural saponin.

4. The anti-pest barrier coating of claim 4 wherein the natural saponin is Yucca Schidigera or Quillaja soapbox saponin that comprises 1-5% of the coating by weight (for a 10× concentrate).

5. The anti-pest barrier coating of claim 1 wherein the elastomeric material is an organic elastomeric polymer.

6. The anti-pest barrier coating of claim 1 wherein the elastomeric material is an acrylic elastomeric polymer.

7. The anti-pest barrier coating of claim 1 further comprising an anti-pathogenic adjunct mixed into the barrier coating.

8. The anti-pest barrier coating of claim 1 wherein the drying or volatile oil has anti-pathogenic properties.

9. The anti-pest barrier coating of claim 1 wherein said oil is an essential oil.

10. The anti-pest barrier coating of claim 1 wherein the coating comprises 0.015% to 20% elastomeric polymer by volume and 0.1 to 10% drying oil by volume dissolved in water and applied to the plant material.

11. The anti-pest coating of claim 1 wherein the plant material is a living plant or a part thereof.

12. The anti-pest coating of claim 1 wherein the oil is a product of plants from the genus of the plant material being treated.

13. A method of protecting plant material from pathogenic infection comprising:
providing plant material at risk of pathogenic infection; and
coating the plant material with a coating including an elastomeric polymer and a drying or volatile oil.

14. The method of claim 13 wherein said method protects a plant from pathogenic infection during grafting, the method comprising:
grafting the tissues of one plant to another plant, thereby creating exposed graft wounds:
wherein the coating is applied to the graft wounds shortly after grafting.

15. The method of claim 13 wherein said method protects a seed from pathogenic infection during storage and handling;
wherein the coating is applied to the seed after collection.

16. The method of claim 13 wherein said method protects a rootstock from pathogenic infection during storage and handling;
wherein said coating is applied to the rootstock after collection.

17. The method of claim 12, wherein said method protects a post-harvest crop;
wherein said coating is applied to the crop after harvest.

18. The method of claim 13 wherein said method protects plant material from pathogenic infection, the method comprising:
pruning the plant; thereby creating pruning wounds;
wherein said coating is applied to the pruning wounds.

19. A anti-pathogenic barrier coating for coating plant material to inhibit infection by a pathogen comprising:
an elastomeric material having elastomeric properties sufficient to seal the plant material;
an anti-pathogenic material; and
an drying or volatile oil.
